(19) United States
(12) Patent Application Publication
(10) Pub. No.: US 2011/0317636 A1
(43) Pub. Date: Dec. 29, 2011

(54) CHANNEL REQUESTS FOR MACHINE-TYPE DEVICES

(76) Inventors: John Diachina, Garner, NC (US); Paul Schliwa-Bertling, Ljungsbro (SE); Andreas Bergström, Vikingstad (SE); Daniel Widell, Vikbolandet (SE)

(21) Appl. No.: 13/053,935

(22) Filed: Mar. 22, 2011

Related U.S. Application Data
(60) Provisional application No. 61/358,147, filed on Jun. 24, 2010.

(51) Int. Cl. H04W 74/08

(52) U.S. Cl. 370/329

(57) ABSTRACT

To access a network, an MTC device sends a channel request message to the network over a random access channel. The channel request message includes a device type indication and a resource type indication. The device type indication may for example, indicate to the network that the requesting device is an MTC device or non-MTC device. Upon receipt of the channel request, the receiving network node can determine on the basis of the device type indication and resource type indication whether to grant or deny the access attempt, and to determine what resources to grant. The channel request message may further include a call duration indication in the channel request message if CS resources are requested for a voice call or a priority indication if CS resources are requested for a data transmission.

### RELATED APPLICATION

This application claims the benefit of U.S. Provisional Patent Application 61/358,147 filed Jun. 24, 2010, which is incorporated herein by reference.

### BACKGROUND

The present invention relates generally to random access procedures in mobile communication networks and, more particularly, to random access procedures for machine-type wireless terminals.

The random access channel (RACH) in mobile communication networks provides contention-based access to wireless terminals to request connection setup when no radio resources have been allocated to the wireless terminal. In systems based on the GSM/EDGE standard, the wireless terminal sends an access request message to the network on the RACH to request allocation of resources. The access request message includes a randomly generated bit sequence which, together with the rest of the information provided within the access request, is referred to in some protocols as the Request Reference information. The Request Reference is used for identification purposes during contention resolution and provides some degree of uniqueness for the accessing wireless terminal in lieu of a larger identifier such as the IMSI (i.e. the Request Reference minimizes the amount of information the wireless terminal needs to send during the initial part of contention resolution process). The wireless terminal then monitors the Access Grant Channel (AGCH) for a response. The network may either accept or deny the access request. If it accepts it, the network transmits an Immediate Assignment (IA) message on the AGCH, identifying the wireless terminal by the Request Reference value included in the access request message and assigning it radio resources. If the network denies access to the requesting wireless terminal, it transmits an Immediate Assignment Reject (IAR) message identifying the wireless terminal by the Request Reference value included in the access request message.

The anticipated introduction of a large volume of machine-type communication (MTC) devices in the near future will greatly increase the demand on the resources of the communication network. MTC devices are devices, such as meters or sensors, that collect and send data to an MTC server or other MTC device over a communication network. It is expected that MTC devices will far outnumber non-MTC devices, such as user terminals for voice and data communications by human users. It would be beneficial to know the type of device and the type of requested resources when an MTC device attempts to access the network. This information could be factored into decision by the network to grant or deny access to the network and to allocate resources to the requesting device.

### SUMMARY

The present invention provides methods and apparatus for controlling network access by MTC devices or other wireless terminals. To access the network, the MTC device sends an access request message (also known as a channel request message) to the network over a random access channel. The channel request message includes a device type indication and a resource type indication. The device type indication may, for example, indicate to the network that the requesting device is an MTC device or non-MTC device. The resource type indication may for example, indicate that the request is for circuit-switched (CS) or packet-switched (PS) resources. Upon receipt of the channel request message, the receiving network node can determine on the basis of the device type indication and resource type indication whether to accept or reject the access attempt, and to determine what resources to grant.

In some embodiments of the invention, the channel request message may include additional call related parameters. For example, in the case of a voice call, the requesting device may include a call duration indication in the channel request message. In the case of a data transmission, the requesting device may include a priority indication in the channel request message. The network can factor the additional call-related parameters in its decision to accept or reject the system access, and to determine what resources to grant.

Exemplary embodiments of the invention comprise random access methods implemented by a wireless terminal. In one exemplary random access method, the wireless terminal sends a channel request message over a random access channel to the network to request assignment of resources. The channel request message includes a device-type indication specifying a type of the requesting wireless terminal (e.g., MTC or non-MTC) and a resource type indication specifying the type of resources requested (e.g., CS or PS). For the case where the resource type indicates that CS resources are requested, the channel request message includes an access type indication specifying the type of access requested (e.g., a CS resource for voice call or a CS resource for a data transmission).

In another exemplary random access method, the wireless terminal sends a channel request message over a random access channel to the network to request assignment of CS resources for a voice call. The resource type (i.e. CS resources) and access type (i.e. voice call) may be specified respectively by a resource type and access type indication in the channel request message. The channel request message includes a device-type indication specifying a type of the requesting wireless terminal (e.g., MTC or non-MTC), and a call duration indication specifying an expected duration of the call.

In another exemplary embodiment, the wireless terminal sends a channel request message over a random access channel to the network to request assignment of CS resources for a data transmission. The resource type (i.e. CS resources) and access type (i.e. data transmission) may be specified respectively by a resource type and access type indication in the channel request message. The channel request message includes a device-type indication specifying a type of the requesting wireless terminal (e.g., MTC or non-MTC device), and a priority indication specifying the priority of the data transmission.

Some embodiments of the invention comprise wireless terminals configured to access a network over a random access channel. One exemplary wireless terminal comprises a transceiver for communicating with a base station in a wireless communication network, and a processing circuit configured to control operation of said transceiver. The processing circuit includes a radio resource controller configured to send a channel request message over a random access channel to the network to request assignment of resources. The channel request message includes a device type indication specifying the device type of the requesting wireless terminal (e.g., MTC or non-MTC) and a resource type indication specifying the type of requested resources (e.g., CS or PS).

Another exemplary wireless terminal comprises a transceiver for communicating with a base station in a wireless communication network, and a processing circuit configured to control operation of said transceiver. The processing circuit includes a radio resource controller configured to send a channel request message over a random access channel to the network to request assignment of CS resources for a voice call. The resource type (i.e. CS resources) and access type (i.e. voice call) may be specified respectively by a resource type and access type indication in the channel request message. The channel request message includes a device type indication specifying a type of the requesting wireless terminal, and call duration indication specifying an expected duration of the voice call.

Still another wireless terminal comprises a transceiver for communicating with a base station in a wireless communication network, and a processing circuit configured to control operation of said transceiver. The processing circuit includes a radio resource controller configured to send a channel request message over a random access channel to the network to request assignment of CS resources for a data transmission. The resource type (i.e. CS resources) and access type (i.e. data transmission) may be specified respectively by a resource type and access type indication in the channel request message. The channel request message includes a device type indication specifying a type of the requesting wireless terminal, and priority indication specifying a priority of the data transmission.

Exemplary embodiments of the invention comprise access control methods implemented by a base station or other network node in a mobile communication network. In one exemplary embodiment, the base station or network node receives a channel request message over a random access channel from a wireless terminal. The base station determines a type of the requesting wireless terminal from a device type indication in the channel request message and the type of the requested resource from a resource type indication in the channel request message. The base station grants access to the requested resource based on said indicated device type and resource type.

In another exemplary access control method, the base station or network node receives, from a wireless terminal over a random access channel, a channel request message requesting assignment of CS resources for a voice call. The resource type (i.e. CS resources) and access type (i.e. voice call) may be specified respectively by a resource type and access type indication in the channel request message. The base station determines a type of the requesting wireless terminal from a device type indication in the channel request message, and the expected duration of the voice call from a call duration indication in the channel request message. The base station grants access to the requested resource based on said indicated device type and call duration.

In another exemplary access control method, the base station or network node receives, from a wireless terminal over a random access channel, a channel request message requesting assignment of CS resources for a data transmission. The resource type (i.e. CS resources) and access type (i.e. data transmission) may be specified respectively by a resource type and access type indication in the channel request message. The base station determines a type of the requesting wireless terminal from a device type indication in the channel request message, and the priority of the data transmission from a priority indication in the channel request message. The base station grants access to the requested resource based on said indicated device type and priority.

Other exemplary embodiments comprise base stations for controlling network access by wireless terminals. One exemplary base station comprises a transceiver circuit for communicating with wireless terminals, and a processing circuit configured to control operation of said transceiver circuit. The processing circuit includes a radio resource controller configured to receive, from a wireless terminal over a random access channel, a channel request message requesting assignment of resources; to determine a type of the requesting wireless terminal from a device type indication in said channel request message; to determine a type of the requested resource from a resource type indication in the channel request message; and to grant access to the requested resource based on said indicated device type and resource type.

Another exemplary embodiment of the base station comprises a transceiver circuit for communicating with wireless terminals, and a processing circuit configured to control operation of said transceiver circuit. The processing circuit includes a radio resource controller configured to receive, from a wireless terminal over a random access channel, a channel request message requesting assignment of CS resources for a voice call. The resource type (i.e. CS resources) and access type (i.e. voice call) may be specified respectively by a resource type and access type indication in the channel request message. The radio resource controller is further configured to obtain device type information, and call duration information from said channel request message; and to grant access to the requested resource based on said indicated device type and call duration.

Another exemplary embodiment of the base station comprises a transceiver circuit for communicating with wireless terminals, and a processing circuit configured to control operation of said transceiver circuit. The processing circuit includes a radio resource controller configured to receive, from a wireless terminal over a random access channel, a channel request message requesting assignment of CS resources for a data transmission. The resource type (i.e. CS resources) and access type (i.e. data transmission) may be specified respectively by a resource type and access type indication in the channel request message. The radio resource controller is further configured to obtain device type information, and call duration information from the channel request message; and to grant access to the requested resource based on said indicated device type and call duration.

### BRIEF DESCRIPTION OF THE DRAWINGS

FIG. 1 illustrates an exemplary communication network for communication by MTC devices.

FIG. 2 illustrates an exemplary random access procedure implemented by a wireless terminal for requesting assignment of resources

FIG. 3 illustrates an exemplary access control method implemented by a base station for controlling network access by MTC devices.

FIG. 4 illustrates another random access procedure implemented by a wireless terminal for requesting assignment of CS resources for a voice call.

FIG. 5 illustrates another access control method implemented by a base station for controlling network access by MTC devices for voice calls.

FIG. 6 illustrates another random access procedure implemented by a wireless terminal for requesting assignment of CS resources for a data transmission.

FIG. 7 illustrates another access control method implemented by a base station for controlling network access by MTC devices for data transmissions.

FIG. 8 illustrates an exemplary channel request message.

FIG. 9 illustrates an exemplary wireless terminal for performing random access procedures as herein described.

FIG. 10 illustrates an exemplary base station to control network access by MTC devices as herein described.

### DETAILED DESCRIPTION

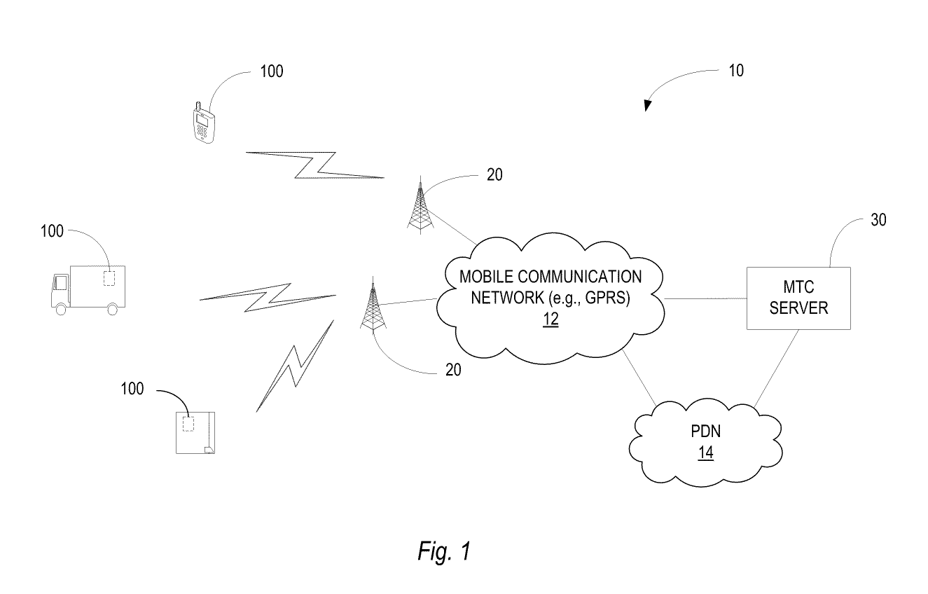

Referring now to the drawings, FIG. 1 illustrates an exemplary wireless communication network 10 including a core network 12, a plurality of base stations 20, and a plurality of wireless terminals 100. The communication network 10 may, for example, comprise a mobile communication network 12 that operates according to any communication standard that employs a contention-based random access channel (RACH). For illustrative purposes, an exemplary embodiment of the present invention will be described in the context of a network operating according to the GSM/EDGE (Global System for Mobile Communication (GSM) Packet Radio Service) standard. Those skilled in the art will appreciate, however, that the present invention is more generally applicable to other wireless communication systems, including Wideband Code Division Multiple Access (WCDMA), Long-Term Evolution (LTE), and Worldwide Interoperability for Microwave Access (WiMAX) systems. The mobile communication network 12 includes a plurality of base stations 20 that provide network access to mobile wireless terminals 100. The mobile communication network 12 connects to an external packet data network 14, such as the Internet. The wireless terminals 100 may communicate with one or more servers 30 connected to the mobile communication network 12 or packet data network 14.

The wireless terminals 100 may comprise machine-type communication (MTC) devices for collecting and reporting of data over a communication network or non-MTC devices. Machine Type Communications (MTC) has been defined as a specific type of wireless communication network traffic. See, e.g., 3GPP Technical Report 23.888, “System Improvements for Machine-Type Communications,” the disclosure of which is incorporated herein by reference in its entirety. One example of an MTC device is a gas or power meter with a wireless transceiver for reporting at predetermined time periods usage of gas or electrical power to the MTC server 30. Non-MTC devices are devices, such as a cell phone, smart phone, laptop computer, etc., used for voice and data communications by human users. An MTC device may comprise a dedicated device specifically for data collection and reporting. In other embodiments, a combined wireless terminal 100 may function part of the time as a MTC device and part of the time as a non-MTC device.

In order to send the data, a wireless terminal 100 must first establish a connection with the communication network 10. Typically, the wireless terminal 100 registers with the communication network 10 on power up. After registering with the network 10, the wireless terminal 100 may enter an IDLE mode. In the IDLE mode, the wireless terminal 100 does not have an established connection with a base station 20. When the wireless terminal 100 has data to send, it uses a random access procedure to request assignment of resources. In one exemplary embodiment for a GSM/EDGE network, the mobile wireless terminal initiates the random access procedure by sending a channel request message to the network over a random access channel. In response to the channel request message, the base station 20 may decide to allow the access attempt or to deny the access attempt. If the access attempt is allowed, the base station 20 assigns resources for the system access.

In exemplary embodiment of the present invention, the channel request message sent by an MTC device includes a device type indication specifying to the network the type of the requesting device. For example, the device type indication may indicate to the network that it is either an MTC device or non-MTC device. Other device types could also be defined. The channel request message may also include service related information, indicating, for example, type of resources being requested, the expected call duration, a priority, and other service related information. The network may factor the device type and service related information received as part of the channel request into its decision whether to grant or deny access and what resources to grant.

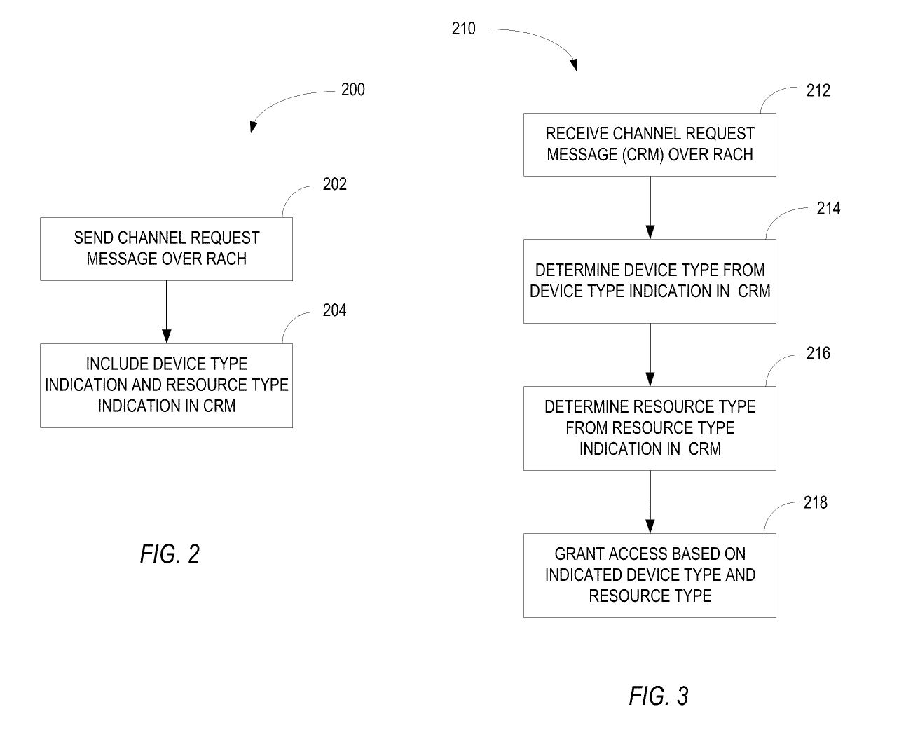

FIG. 2 illustrates an exemplary random access procedure 200 implemented by a wireless terminal 100 according to one embodiment. When the wireless terminal 100 has data to send, the wireless terminal 100 sends a channel request message (CRM) over a random access channel (RACH) to the base station 20 (block 202). The wireless terminal 100 includes in the CRM a device-type indictor and resource-type indication (block 204). The device-type indication indicates the type of the requesting wireless terminal 100, and the resource-type indication indicates the type of resources being requested. For example, the device-type indication may indicate to the base station 20 that the wireless terminal 100 is either an MTC device or non-MTC device. The resource-type indication may indicate that assignment of either circuit-switched (CS) resources or packet-switched (PS) resources is being requested by the wireless terminal.

FIG. 3 illustrates a corresponding access control method 210 implemented by the base station 20. The base station 20 receives the channel request message from the wireless terminal 100 over the random access channel (block 212). Upon receipt of the channel request message, the base station 20 determines the type of the requesting wireless terminal 100 from the device-type indication (block 214) and the type of resources requested from the resource-type indication (block 216). Based on the indicated device type and resource type, the base station 20 either accepts or rejects the access attempt (block 218). If the access attempt is accepted, the base station 20 grants resources to the wireless terminal 100. The wireless terminal 100 may be notified of the grant decision by sending a grant message (e.g., immediate assignment message) to the wireless terminal 100.

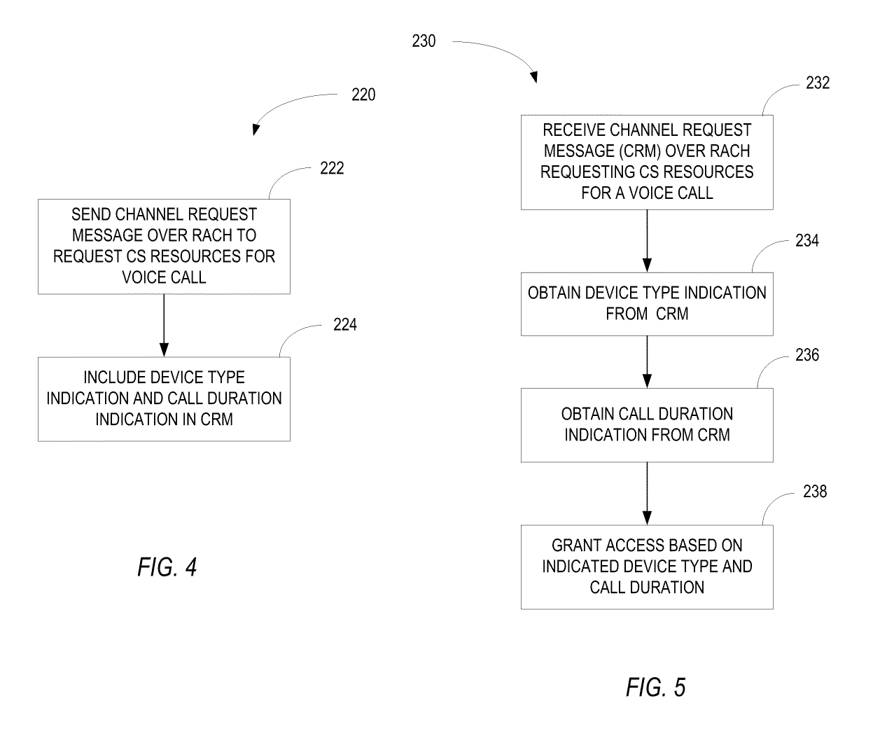

FIG. 4 illustrates another exemplary random access procedure 220 implemented by a wireless terminal 100. In this embodiment, the wireless terminal 100 sends a channel request message over a random access channel to the base station 20 to request assignment of CS resources for a voice call (block 222). The resource type (i.e. CS resources) and access type (i.e. voice call) may be specified respectively by a resource type and access type indication in the channel request message. The wireless terminal 100 includes a device-type indication and call duration indication in the channel request message (block 224). The device-type indication may indicate, for example, that the wireless terminal 100 is either an MTC or non-MTC device. Other device types could be defined. The call duration indication specifies the expected maximum duration of the call. As will be hereinafter described, the wireless terminal 100 may be pre-configured with a subset of permissible call durations. The call duration indication may comprise two or more bits indicating one of the pre-configured call durations. For example, two bits can be used to indicate call durations of 15 seconds, 30 seconds, 60 seconds, and unlimited. Additional bits could be used to produce finer gradations in call duration.

FIG. 5 illustrates a corresponding access control method 230 implemented by the base station 20. The base station 20 receives, from a wireless terminal 100 over a random access channel, a channel request message requesting CS resources for a voice call (block 232). The resource type (i.e. CS resources) and access type (i.e. voice call) may be specified respectively by a resource type and access type indication in the channel request message. The base station 20 obtains device-type information and call duration information from the channel request message (blocks 234, 236). The device-type information may indicate, for example, that the requesting wireless terminal 100 is either an MTC device or non-MTC device. The call duration information specifies the expected call duration from a predetermined set of permissible call durations. Based on the device-type information and call duration information in the channel request message, the base station 20 determines whether to accept or reject the access attempt and, if accepted, what resources to grant (block 238).

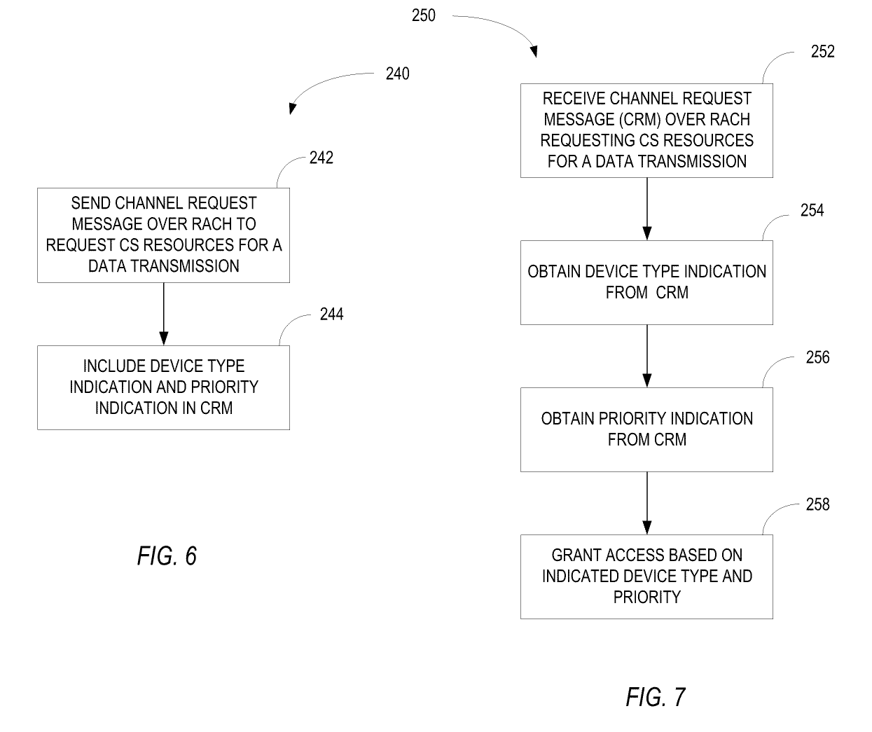

FIG. 6 illustrates another exemplary random access procedure 240 implemented by a wireless terminal 100. In this embodiment, the wireless terminal 100 sends a channel request message over a random access channel to the base station 20 to request CS resources for a data transmission (e.g., SMS message) (block 242). The resource type (i.e. CS resources) and access type (i.e. data transmission) may be specified respectively by a resource type and access type indication in the channel request message. The wireless terminal 100 includes a device-type indication and priority indication in the channel request message (block 244). The device-type indication may indicate, for example, that the wireless terminal 100 is either an MTC or non-MTC device. Other device types could be defined. The priority indication specifies the priority of the data transmission. As will be hereinafter described, the wireless terminal 100 may be pre-configured with a subset of permissible priorities. The priority indication may comprise two or more bits indicating one of the pre-configured call durations.

FIG. 7 illustrates a corresponding access control method 250 implemented by the base station 20. The base station 20 receives, from a wireless terminal 100 over a random access channel, a channel request message requesting CS resources for a data transmission (block 252). The resource type (i.e. CS resources) and access type (i.e. data transmission) may be specified respectively by a resource type and access type indication in the channel request message. The base station 20 obtains device-type information and priority information from the channel request message blocks 254, 256). The device-type information may indicate, for example, that the requesting wireless terminal 100 is either an MTC device or non-MTC device. The priority information specifies a priority of the data transmission. Based on the device-type information and priority information in the channel request message, the base station 20 determines whether to accept or reject the access attempt and, if accepted, what resources to grant (block 258).

The procedures shown in FIGS. 2-7 can be implemented in GSM/EDGE networks using the EGPRS packet channel request message transmitted over a packet random access channel (PRACH). The EGPRS packet channel request message comprises eleven bits providing a Request Reference used for identification purposes during contention resolution and provides some degree of uniqueness for the requesting wireless terminal 100. Unused code points within the EGPRS packet channel request message can be used to indicate when an MTC device is attempting a system access, the type of resources (e.g., CS or PS) being requested, and the access type (e.g. voice call or data transmission). Depending on the access type, bits in the EGPRS packet channel request message can be used to indicate call duration (for voice calls) or priority (for data transmission).

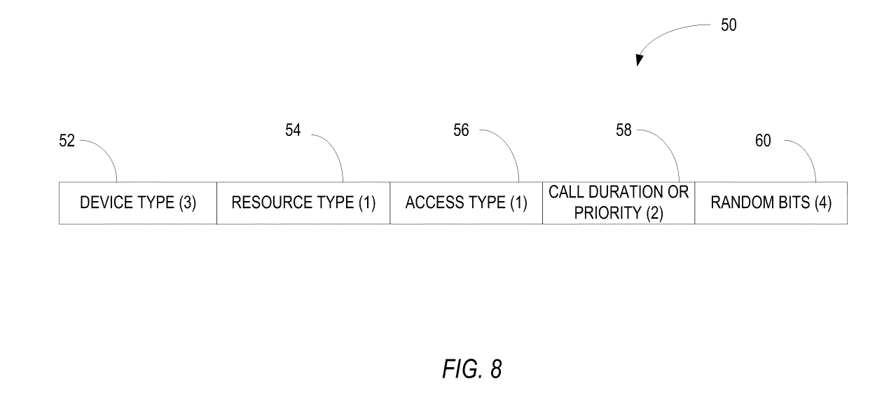

FIG. 8 illustrates an exemplary EGPRS packet channel request message 50 for implementing the procedures shown in FIGS. 2-5. As shown in FIG. 6, the EGPRS packet channel request message comprises a device-type indication (3 bits) 52, a resource-type indication (1 bit) 54, an access-type indication (1 bit) 56, a call duration indication or priority indication depending on the access type (2 bits) 58, and four random bits (4 bits) 60. In this embodiment, a device-type indication with a value of “111” indicates that the requesting device is an MTC device. The resource-type indication is set to “0” for packet-switched resources and to “1” for circuit-switched resources. The message structure is fully compliant with the existing GSM/EDGE standard.

By including a device type and resource type indication in the channel request message, a base station 20 is able to determine when an MTC device is attempting to access the network and the type of resource requested, which may factor into the base station's decision to accept or reject any given access attempt. Additionally, when an MTC device requests assignment of CS resources, it may indicate whether the CS resources will be used for a voice call or data transmission (e.g., SMS message) by including an access type indication. In the case of a voice call, the MTC device can indicate the expected duration of the voice call. In the case of a data transmission, the MTC device may indicate the priority of the data transmission. Allowing the wireless terminal 100 to indicate the type of activity (voice or data transmission), as well as call-related parameters (e.g., call duration or priority) enables the base station 20 to take these factors into account when making radio resource management decisions.

When an MTC device is activated, it can be configured to support a predetermined set of possible call durations for voice calls, and a predetermined set of priorities for data transmissions. For example, as noted above, the MTC device may be configured to support calls having maximum duration of 15, 30, 60, and unlimited minutes. Any one of four different priorities for data transmissions may be indicated.

A number of different methods may be used to configure the MTC device with permissible call durations and priorities. These methods include:
1) pre-configuring the SIM card of an MTC device with a set of permissible call durations and a set of priorities;
2) over-the-air (OTA) programming to configure the MTC device with a set of permissible call durations and a set of priorities;
3) 3GPP non-access stratum (NAS) signaling to configure the MTC device with a set of permissible call durations and a set of priorities. For example, NAS signaling could be used to configure the MTC device during a GPRS attach procedure. Alternatively, NAS signaling between the MTC device and an MTC server can be used to configure the MTC device.

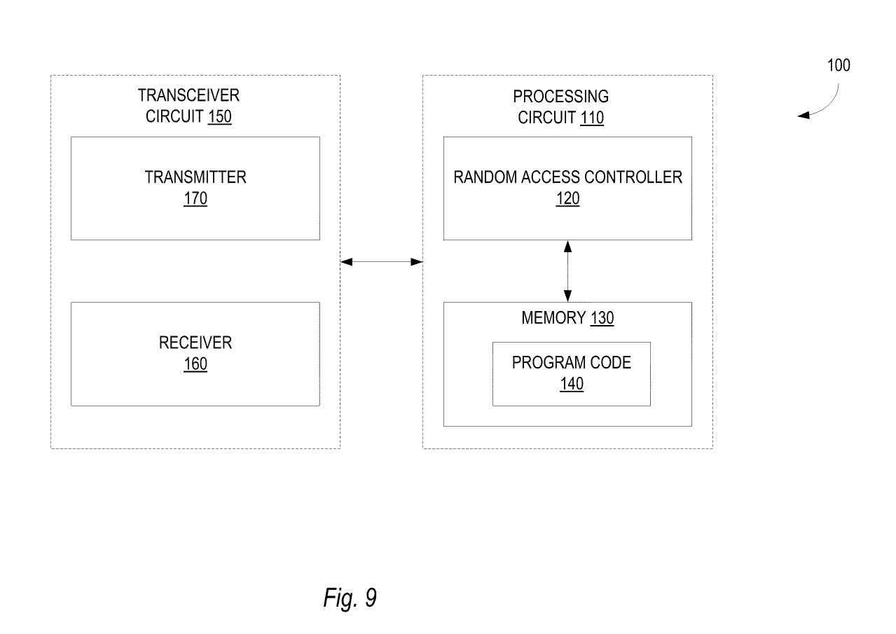

FIG. 9 illustrates an exemplary wireless terminal 100 that may function as an MTC device, non-MTC device, or both. The wireless terminal 100 includes a processing circuit 110 connected to a transceiver circuit 150 that communicates with base stations 20 in the mobile communication network 10. The processing circuit 110 includes a random access controller 120 and memory 130 for storing program code 140 controlling operation of the wireless terminal 100. The program code 140 includes code for performing the random access procedures as herein described. The transceiver circuit 150 comprises a receiver 160 and transmitter 170 for communicating with the base station 20. The transceiver circuit 150 may operate, for example, according to the GSM/EDGE standard or other communication standard.

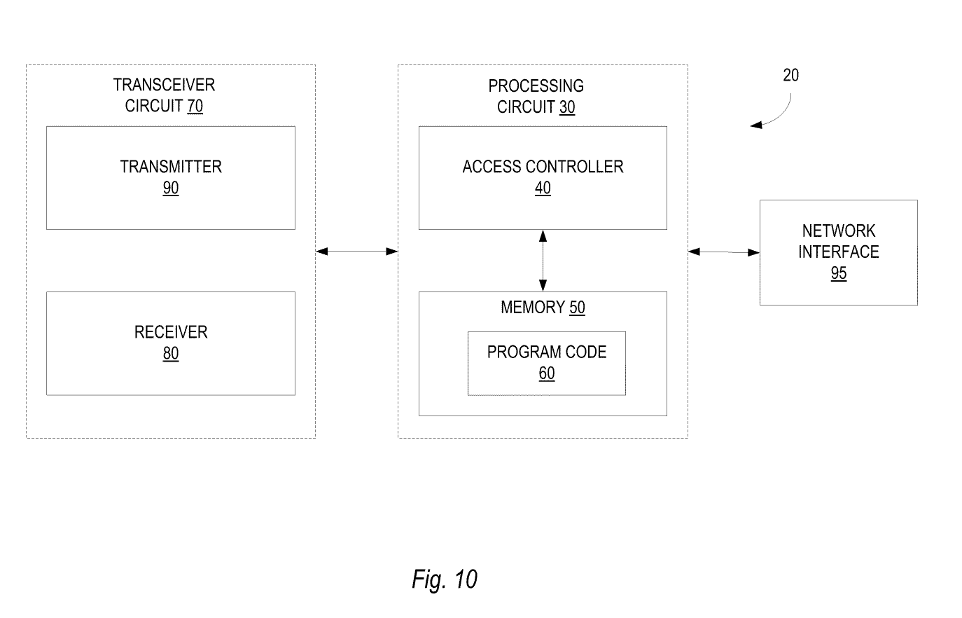

FIG. 10 illustrates an exemplary base station 20 that implements the access control functions as herein described. The base station 20 includes a processing circuit 30 connected to a wireless transceiver circuit 50 that communicates with wireless terminals 100 in the mobile communication network 10, and a network interface 95. The processing circuit 30 includes an access controller 40 and memory 50 for storing program code 60 controlling operation of the base station 20. The program code 60 includes code for performing the access control procedures as herein described. The transceiver circuit 70 comprises a receiver 80 and transmitter 90 for communicating with the base station 20. The transceiver circuit 70 may operate, for example, according to the GSM/EDGE standard or other communication standard. The network interface 95 enables the base station 20 to communicate with other base stations 20 and network nodes within the core network 12.

The present invention may, of course, be carried out in other specific ways than those herein set forth without departing from the scope and essential characteristics of the invention. The present embodiments are, therefore, to be considered in all respects as illustrative and not restrictive, and all changes coming within the meaning and equivalency range of the appended claims are intended to be embraced therein.

What is claimed is:

1. A method of random access implemented by a wireless terminal in a wireless communication network having circuit-switched (CS) resources and packet-switched (PS) resources, said method comprising:
sending a channel request message over a random access channel from said wireless terminal to said network to request assignment of resources; and
including in said channel request message a device type indication and resource type indication specifying respectively the device type of the requesting wireless terminal and the type of requested resources.

2. The method of claim 1 further comprising including, in a channel request message requesting assignment of CS resources for a voice call, a call duration indication.

3. The method of claim 2 wherein the call duration indication comprises predetermined bit patterns corresponding to a predetermined set of permissible call durations.

4. The method of claim 1 further comprising including, in a channel request message requesting assignment of CS resources for a data transmission, a priority indication.

5. The method of claim 4 wherein the priority indication comprises predetermined bit patterns corresponding to a predetermined set of priorities.

6. A method of random access implemented by a base station in a wireless communication network, said method comprising:
receiving a channel request message over a random access channel from a wireless terminal requesting assignment of resources; and
determining a device type of the requesting wireless terminal from a device type indication in said channel request message;
determining a type of a requested resource from a resource type indication in said channel request message;
granting access to the requested resource based on said indicated device type and resource type.

7. The method of claim 6 further comprising determining an expected call duration from a call duration indication in a channel request message requesting assignment of CS resources for a voice call.

8. The method of claim 7 wherein the call duration indication comprises predetermined bit patterns corresponding to a predetermined set of permissible call durations.

9. The method of claim 6 further comprising determining a priority of a data transmission from a priority indication in a channel request message requesting CS resources for a data transmission.

10. The method of claim 9 wherein the priority indication comprises predetermined bit patterns corresponding to a predetermined set of priorities.

11. A wireless terminal comprising:
a transceiver for communicating with a base station in a wireless communication network;
a processing circuit configured to control operation of said transceiver, said processing circuit including a random access controller configured to:
send a channel request message over a random access channel from said wireless terminal to said network to request assignment of resources; and
include in said channel request message a device type indication and resource type indication specifying respectively the device type of the requesting wireless terminal and a type of requested resources.

12. The wireless terminal of claim 11 wherein said channel request message requests assignment of CS resources for a voice call and wherein the random access controller is further configured to include a call duration indication in said channel request message.

13. The wireless terminal of claim 12 wherein the call duration indication comprises predetermined bit patterns corresponding to a predetermined set of permissible call durations.

14. The wireless terminal of claim 11 wherein said channel request message requests assignment of CS resources for a data transmission, and wherein said random access controller is further configured to include a priority indication in said channel request message.

15. The wireless terminal of claim 14 wherein the priority indication comprises predetermined bit patterns corresponding to a predetermined set of priorities.

16. A base station in a wireless communication network, said base station comprising:
a transceiver circuit for communicating with wireless terminals;
a processing circuit configured to control operation of said transceiver circuit, said processing circuit including a access controller configured to:
receive, from a wireless terminal over a random access channel, a channel request message requesting assignment of resources;
determine a type of the requesting wireless terminal from a device type indication in the channel request message;
determine a type of a requested resource from a resource type indication in said channel request message;
grant access to the requested resource based on said indicated device type and resource type.

17. The base station of claim 16 wherein said access controller is further configured to detect a call duration indication in a channel request message requesting assignment of CS resources for a voice call.

18. The base station of claim 17 wherein the call duration indication comprises predetermined bit patterns corresponding to a predetermined set of permissible call durations.

19. The base station of claim 16 wherein said access controller is further configured to detect a priority indication in a channel request message requesting assignment of CS resources for a data transmission.

20. The base station of claim 19 wherein the priority indication comprises predetermined bit patterns corresponding to a predetermined set of priorities.

21. A method of random access in a wireless communication network, said method comprising:
sending a channel request message to the network over a random access channel to request assignment of CS resources for a voice call; and
transmitting device type information and call duration information to said base station in said channel request message.

22. The method of claim 21 wherein the device type information indicates that the wireless terminal comprises a machine-type communication (MTC) device.

23. The method of claim 22 wherein the call duration information indicates one of a predetermined set of permissible call durations.

24. A method of controlling access to circuit-switched resources in a wireless communication network, said method comprising:
receiving, from a wireless terminal over a random access channel, a channel request message requesting assignment of CS resources for a voice call;
obtaining device type information and call duration information from said channel request message; and
granting access to the requested resource based on the device type information and the call duration information.

25. The method of claim 24 wherein the device type information indicates that the wireless terminal comprises a machine-type communication (MTC) device.

26. The method of claim 24 wherein the call duration information indicates one of a predetermined set of permissible call durations.

27. A wireless terminal comprising:
a transceiver for communicating with a base station in a wireless communication network;
a processing circuit configured to control operation of said transceiver, said processing circuit including a random access controller configured to:
send a channel request message to the network over a random access channel to request assignment of CS resources for a voice call; and
transmit device type information and call duration information to said base station in said channel request message.

28. The wireless terminal of claim 27 wherein the device type information indicates that the wireless terminal comprises a machine-type communication (MTC) device.

29. The wireless terminal of claim 27 wherein the call duration information indicates one of a predetermined set of permissible call durations.

30. A base station in a wireless communication network, said base station comprising:
a transceiver circuit for communicating with wireless terminals;
a processing circuit configured to control operation of said transceiver circuit, said processing circuit including a access controller configured to:
receive, from a wireless terminal over a random access channel, a channel request message requesting assignment of CS resources for a voice call;
obtain device type information and call duration information from said channel request message; and
grant access to the requested resource based on the device type information and the call duration information.

31. The base station of claim 30 wherein the device type information indicates that the wireless terminal comprises a machine-type communication (MTC) device.

32. The base station of claim 30 wherein the call duration information indicates one of a predetermined set of permissible call durations.

33. A method of random access in a wireless communication network, said method comprising:
sending a channel request message to the network over a random access channel to request assignment of CS resources for a data transmission; and
transmitting device type information and priority information to said base station in said channel request message.

34. The method of claim 33 wherein the device type information indicates that the wireless terminal comprises a machine-type communication (MTC) device.

35. The method of claim 34 wherein the priority information indicates one of a predetermined set of permissible priorities.

36. A method of controlling access to circuit-switched resources in a wireless communication network, said method comprising:
receiving, from a wireless terminal over a random access channel, a channel request message requesting assignment of CS resources for a data transmission;
obtaining device type information and priority information from said channel request message; and
granting access to the requested resource based on the device type information and the priority information.

37. The method of claim 36 wherein the device type information indicates that the wireless terminal comprises a machine-type communication (MTC) device.

38. The method of claim 36 wherein the priority information indicates one of a predetermined set of permissible priorities.

39. A wireless terminal comprising:
a transceiver for communicating with a base station in a wireless communication network;
a processing configured to control operation of said transceiver, said processing circuit including a random access controller configured to:
send a channel request message to the network over a random access channel to request assignment of CS resources for a data transmission; and
transmit device type information and priority information to said base station in said channel request message.

40. The wireless terminal of claim 39 wherein the device type information indicates that the wireless terminal comprises a machine-type communication (MTC) device.

41. The wireless terminal of claim 39 wherein the priority information indicates one of a predetermined set of permissible priorities.

42. A base station in a wireless communication network, said base station comprising:
a transceiver circuit for communicating with wireless terminals;
a processing circuit configured to control operation of said transceiver circuit, said processing circuit including an access controller configured to:
receive, from a wireless terminal over a random access channel, a channel request message requesting assignment of CS resources for a data transmission;
obtain device type information and priority information from said channel request message; and
grant access to the requested resource based on the device type information and the priority information.

43. The base station of claim 42 wherein the device type information indicates that the wireless terminal comprises a machine-type communication (MTC) device.

44. The base station of claim 42 wherein the priority information indicates one of a predetermined set of permissible priorities.
